(19) United States
(12) Patent Application Publication
(10) Pub. No.: US 2019/0249839 A1
(43) Pub. Date: Aug. 15, 2019

(54) LASER-ETCHED LIGHT GUIDE ASSEMBLY

(71) Applicant: VARROC LIGHTING SYSTEMS, s.r.o., Senov u Noveho Jicina (CZ)

(72) Inventors: Colby Childress, Novi, MI (US); Timothy Pelech, Almont, MI (US); Dylan Schickel, Belleville, MI (US)

(21) Appl. No.: 15/896,531

(22) Filed: Feb. 14, 2018

(51) Int. Cl. F21S 41/141; F21S 41/24; B29D 11/00; F21V 8/00

(52) U.S. Cl. CPC F21S 41/141; G02B 6/0065; B29D 11/00663; F21S 41/24

(57) ABSTRACT

A laser-etched light guide assembly includes a light guide, a light source, and a laser-etched feature. The light source is configured to emit light into the light guide. The laser-etched feature is etched upon the light guide, and is adapted to reflect the light for illuminated display of the laser-etched feature.

### BACKGROUND

The present disclosure relates to a light guide assembly, and more particularly, to a laser-etched light guide assembly.

Automotive lamp assemblies, such as headlamps and taillights, include many components arranged in a variety of ways to provide both a utility illumination function and an appealing cosmetic function. Lamp assemblies may include an external clear lens, a plurality of internal lights sources, light reflectors, and light guides known to internally channel light. The light guides may emit the channeled light at light guide features or surfaces formed on the light guide to reflect and/or refract the light. In this way, the features may appear more illuminated than the surrounding light guide portions without the feature. Examples of features may include descriptive elements such as verbiage, logos, and others.

During manufacturing of the light guide, the illuminating features must be machined into the light guide, or may be part of a plastic injection molding process (i.e., first formed into the manufacturing molds). Such processes can be cumbersome, limiting, and may include expensive tooling.

Accordingly, it is desirable to provide a simpler and less expensive means of placing the illuminating features upon the automotive lamp assembly light guide.

### SUMMARY

In one exemplary, non-limiting, embodiment of the present disclosure, an automotive lamp assembly includes a light guide, a light source, and a laser-etched feature. The light source is configured to emit light into the light guide. The laser-etched feature is etched upon the light guide and adapted to reflect the light for illuminated display of the laser-etched feature.

In another exemplary embodiment, a method of manufacturing a light guide assembly includes the steps of programming a laser device with a prescribed feature, then directing a laser beam from the laser device upon a translucent light guide of an automotive lamp assembly. A feature indicative of the prescribed feature is then etched upon the light guide.

These and other advantages and features will become more apparent from the following description taken in conjunction with the drawings.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is a front view of an automotive lamp assembly as one, non-limiting, exemplary embodiment of the present disclosure;

FIG. 2 is a cross section of the automotive lamp assembly taken along line 2-2 of FIG. 1;

FIG. 3 is a perspective view of a light guide assembly of the automotive lamp assembly;

FIG. 4 is a cross section of the light guide assembly taken along line 4-4 of FIG. 3;

FIG. 5 is a partial, enlarged, cross section of the light guide assembly taken from circle 5 of FIG. 4;

FIG. 6 is a schematic of a laser device and a portion of a light guide of the light guide assembly as a work product; and

FIG. 7 is a flow chart illustrating a method of laser etching an illuminating feature upon the light guide.

### DETAILED DESCRIPTION

Referring now to the Figures, where the invention will be described with reference to specific embodiments, without limiting same, an automotive lamp assembly 20 is illustrated. The automotive lamp assembly 20 is shown as a headlamp assembly; however, other embodiments may include tail lamp assembly, a side lamp assembly, a turn-signal lamp assembly, and others.

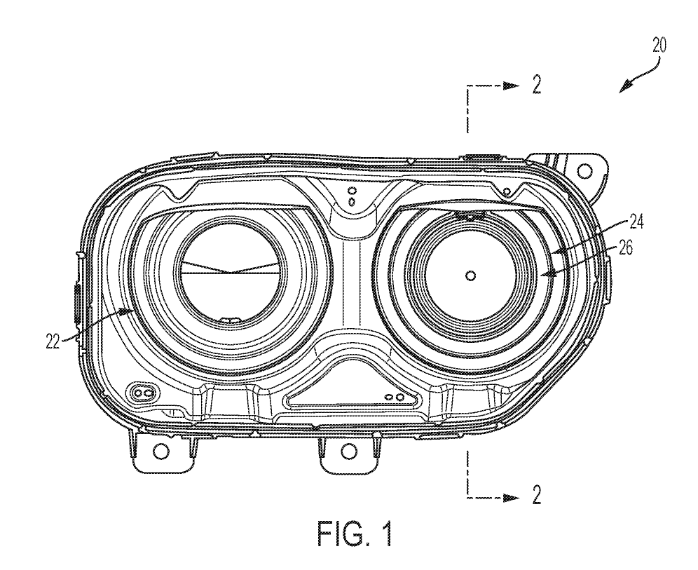

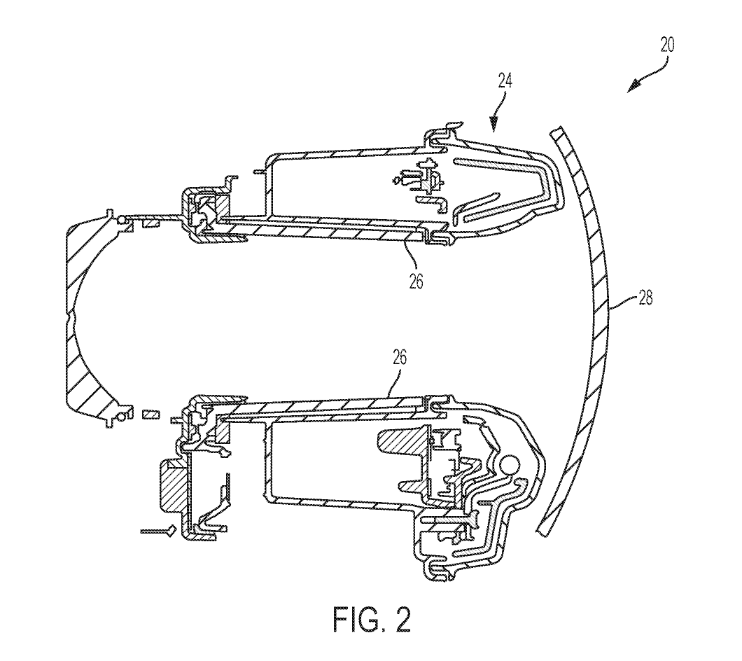

Referring to FIGS. 1 and 2, the automotive lamp assembly 20 may include a head lamp sub-assembly 22 adapted to illuminated a roadway, a turn signal sub-assembly 24, a light guide assembly 26, and an external translucent lens 28 adapted to cover the sub-assemblies 22, 24 and the light guide assembly 26. The automotive lamp assembly 20 may further include other components generally known by one skilled in the art including housing(s), reflectors, and various light sources. In other embodiments, the head lamp sub-assembly 22 may be a full headlamp assembly, and the light guide assembly 26 may be a self-contained lamp capable of be attached to a headlamp.

In one embodiment, the head lamp sub-assembly 22 may be located adjacent to the turn signal sub-assembly 24. The turn signal sub-assembly 24 may be generally annular in shape, and may surround the light guide assembly 26. The light guide assembly 26 may not have a utility function, but may function to display graphics that are aesthetically pleasing.

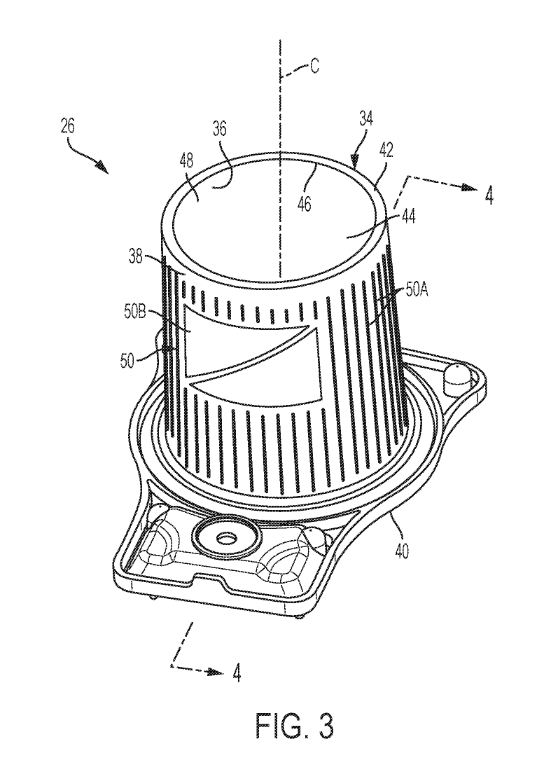

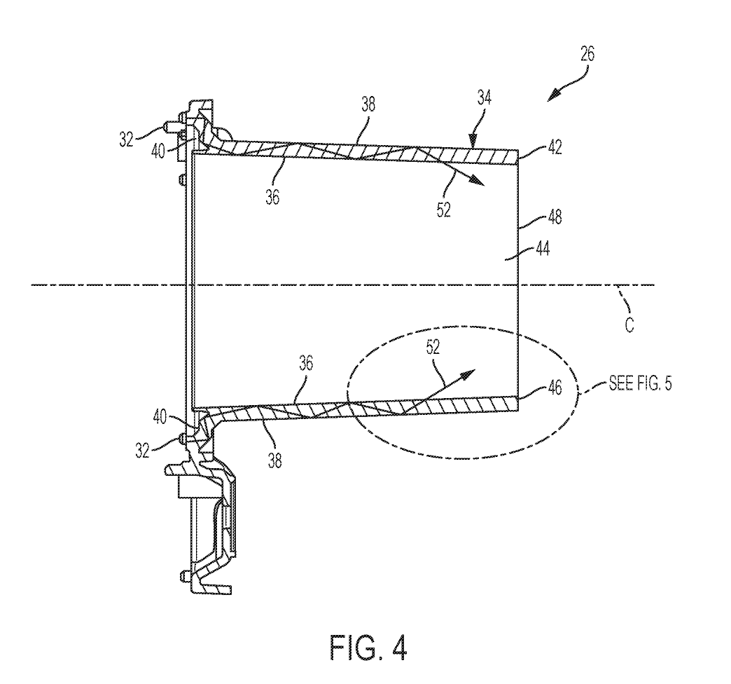

Referring to FIGS. 3 and 4, the light guide assembly 26 may include a light source 32 and a light guide, or blade, 34 that may be generally translucent. The light guide 34 may be tubular (e.g., cylindrical) in shape, and may include an inner surface 36, an outer surface 38, and opposite end faces 40, 42. The inner and outer surfaces 36, 38 may be concentrically located about a centerline C, and may each be circumferentially continuous. The inner surface 36 may substantially face radially inward with respect to the centerline C, and the outer surface 38 may be opposite the inner surface 36 facing substantially radially outward.

The end faces 40, 42 may each span radially and at least between the inner and outer surfaces 36, 38. The inner surface 36 may define the boundaries of a chamber 44 that may be substantially cylindrical. An inner peripheral edge 46 of the end face 42 may generally define the boundaries of an opening 48 in fluid communication with the chamber 44. It is contemplated and understood that the light guide 34 may not be tubular, and may take the form of any shape including a solid rod or bar that may be straight or curved. It is further understood that the tubular light guide 34 may not be cylindrical, and instead, may be conical, square, or any other shape.

The light source 32 of the light guide assembly 26 may be a plurality of light sources (e.g., light emitting diodes) each located adjacent to the end face 40 and spaced circumferentially apart from one another. In one embodiment, the light source 32 may be a secondary light source configured to illuminate the light guide 34 for aesthetic purposes only. In this example, the automotive lamp assembly 20 may be a headlamp assembly that also includes a primary light source (not shown) used to illuminate the road in accordance with, for example, government regulations.

The light guide assembly 26 further includes at least one illuminating feature 50 laser etched upon or into the light guide 34. In one non-limiting example, and as illustrated, the illuminating feature 50 may include a plurality of lines 50A each extending axially with respect to centerline C, spaced circumferentially apart from one another, and etched upon the outer surface 38 for an aesthetic purpose. The illuminating feature 50 may further include an aesthetic design 50B (i.e., a graphic design as illustrated). The feature 50B may be, for example, a logo or trademark. In other embodiments, the feature 50 may be a serial number used to identify the light guide 34, or some other informative marking. It is further contemplated and understood that the laser-etched feature may be etched upon the internal surface 36, or may be etched within the light guide 34, and thus spaced between the inner and outer surfaces 36, 38.

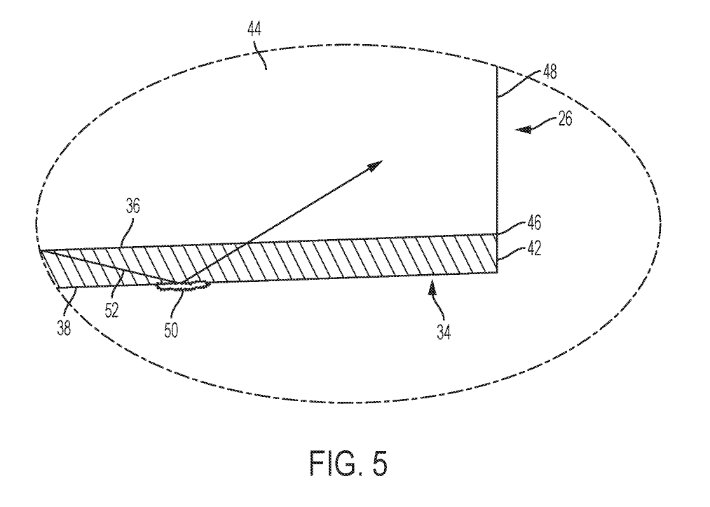

Referring to FIGS. 4 and 5, and during operation of the light guide assembly 26, the light source 32 is adapted to emit a light (i.e., light rays, see arrows 52) through the end face 40 and into the light guide 34. During operation of the light guide 34, the light rays 52 are generally transmitted within the medium of the light guide. In addition, some of the light rays 52 with relatively low incident angles may reflect off of the surfaces 36, 38 and back into the light guide medium.

The illuminating feature(s) 50 may comprise a roughened area or portion of surface 38 that causes some of the light rays to reflect off of the feature and refract through the opposite surface 36. This refraction of the light rays 50 causes the feature 50 to appear illuminated.

With the automotive lamp assembly 20 fully assembled and in operation, the illuminating features 50A, 50B illuminate into the chamber 44, and may be viewed by a person through the opening 48 in the end of the end of the light guide 34.

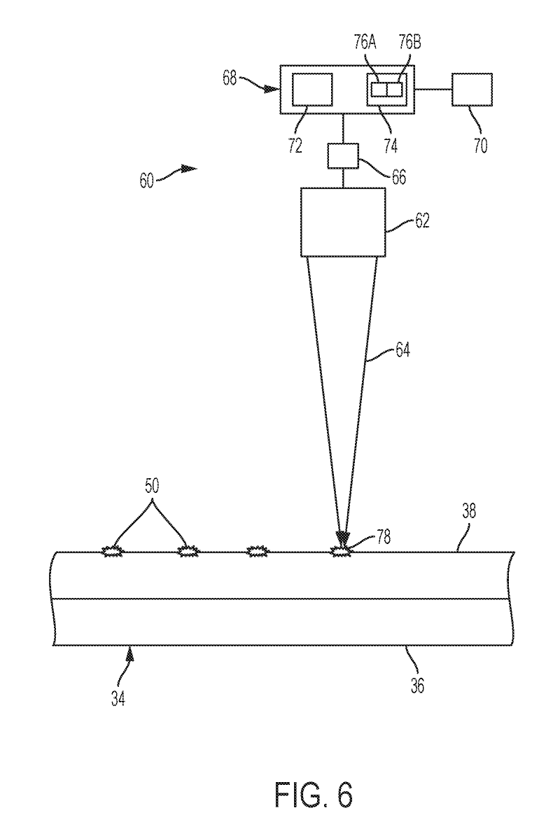

Referring to FIG. 6, during manufacturing of the light guide assembly 26, the light features 50A, 50B may be laser etched into the outer surface 38 of the light guide 34. To achieve this, a laser etching device 60 may include a laser 62 adapted to emit a laser beam 64, a laser positioning apparatus 66, a controller 68, and a user interface 70. The controller 68 may include a processor 72 (e.g., microprocessor) and a computer readable and writeable storage medium 74. In one embodiment, the laser beam 64 may be a convergent laser beam capable of being focused at a desired location.

In one embodiment, the controller 68 may be configured to store and process data relative to a variety of light guide shapes, and a variety of illuminating features relative to each light guide shape or type. For example, a user may enter data, via the user interface 70 indicative of a particular logo to be displayed as the illuminating feature 50 on the light guide 34. The storage medium 74 may store this logo data on one data file of multiple data files 76A, 76B each associated with a unique illuminating feature. Other data files stored in the storage medium 74 may be respectively associated with the shape and size of different light guides.

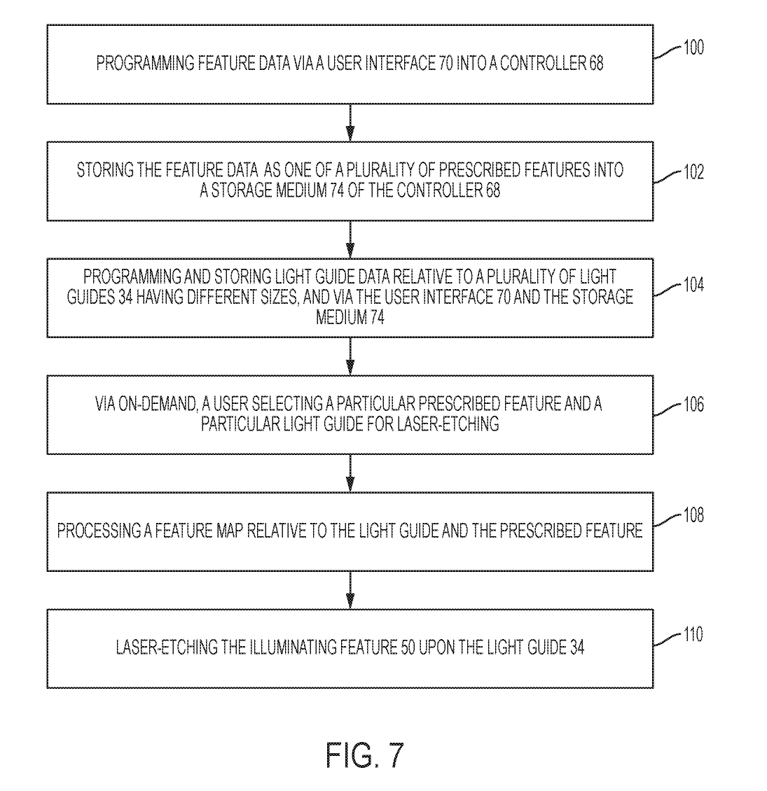

Referring to FIGS. 6 and 7, a method of manufacturing the light guide 34 of the automotive lamp assembly 20 may include at block 100 the entering, or programming, of feature data via the user interface 70 relative to a desired feature to be illuminated. At block 102, this feature data may be stored as one of a plurality of prescribed features (i.e., plurality of data files). At block 104, data may be programmed into the controller 68 via the user interface, and stored in the storage medium 74, relative to a plurality of light guides 34 being of different sizes and shapes. Alternatively, the laser device 60 may have the capability to scan and map the location and shape of each light guide and use this information to appropriately etch the chosen feature 50 onto the light guide 34.

At block 106, a user may select a particular light guide and a particular prescribed feature to etch upon the light guide, and via the user interface 70. At block 108, the processor 72 of the controller 68 processes and coordinates data relative to the light guide shape and the user chosen, prescribed, feature to generally map the feature upon the light guide 34. At block 110, the controller 68 may then control the laser positioning apparatus 66 (i.e., distance from light guide, speed of laser beam 64 passes upon light guide 34, etc.), and the laser 62 (i.e., beam energy, a laser beam focus point 78, etc.) to laser-etch the prescribed feature upon the light guide. It is contemplated and understood, that other control methods may apply when laser-etching the prescribed feature upon the light guide.

In one embodiment, the laser beam 64 may be focused to etch the prescribed feature(s) 76A, 76B onto the opposing surface 38 of the light guide 34 (as illustrated in FIG. 6). In another embodiment, the laser beam 64 may be focused such that the laser beam first passes through the surface 36, and etches the prescribed feature at or near the surface 38. In yet another embodiment, the focus point 78 of the laser beam 64 may be chosen to be spaced between the two surfaces 36, 38, thus spacing the illuminating feature 50 between the surfaces. It is contemplated and understood, that the focus point 78 may be adjusted (or the laser 62 moved) to form a three-dimensional illuminating feature 50 inside, or within, the light guide 34.

Advantages and benefits of the present disclosure include the ability to choose a generic light guide 34 (i.e., one without an illuminating feature 50), and via an efficient on-demand basis, choose and etch the illuminating feature 50 onto the light guide 34. Other benefits include a simplification and reduction of cost when molding the light guide which no longer requires the illuminating feature 50 to be imprinted upon the mold(s). Yet further, benefits may include simplification or elimination of machining processes.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description.

Having thus described the invention, it is claimed:

1. An automotive lamp assembly comprising:
a light guide;
a light source configured to emit light into the light guide; and
a laser-etched feature etched upon the light guide and adapted to reflect the light for illuminated display of the laser-etched feature.

2. The automotive lamp assembly set forth in claim 1, wherein the light guide is generally translucent.

3. The automotive lamp assembly set forth in claim 2, wherein the light guide includes a first surface and an opposite second surface, and the laser-etched feature is located at the second surface.

4. The automotive lamp assembly set forth in claim 3, wherein the laser-etched feature is illuminated and viewed through the first surface.

5. The automotive lamp assembly set forth in claim 2, wherein the light guide includes a first surface and an opposite second surface, and the laser-etched feature is in the light guide and spaced between the first and second surfaces.

6. The automotive lamp assembly set forth in claim 5, wherein the laser-etched feature is three-dimensional.

7. The automotive lamp assembly set forth in claim 4, wherein the light guide is tubular, the first surface faces radially inward, and the second surface faces radially outward.

8. The automotive lamp assembly set forth in claim 7, wherein the light guide includes an annular end face, and the light source is configured to transmit light through the annular end face and into the light guide.

9. The automotive lamp assembly set forth in claim 8, wherein the light guide includes a plurality of light emitting diodes spaced circumferentially about the annular end face.

10. The automotive lamp assembly set forth in claim 7, wherein the first surface defines a chamber, and the light guide includes an end defining an opening in fluid communication with the chamber and through which the laser-etched feature is viewed.

11. The automotive lamp assembly set forth in claim 1, wherein the automotive lamp assembly is a headlamp assembly.

12. A method of manufacturing a light guide assembly comprising:
programming a laser device with a prescribed feature;
directing a laser beam from the laser device upon a translucent light guide of an automotive lamp assembly; and
etching a feature indicative of the prescribed feature upon the light guide.

13. The method set forth in claim 12, further comprising:
focusing the laser beam to transmit through a portion of the light guide.

14. The method set forth in claim 13, further comprising:
transmitting the laser beam through a first surface of the light guide to etch an opposite second surface of the light guide.

15. The method set forth in claim 13, further comprising:
transmitting the laser beam through a first surface of the light guide to etch the feature within the light guide, such that the feature is spaced between a first surface of the light guide and an opposite second surface of the light guide.

16. The method set forth in claim 14, wherein the light guide is tubular, the first surface faces radially inward, and the second surface faces radially outward.

17. The method set forth in claim 12, wherein the laser beam is a convergent laser beam.

18. The method set forth in claim 12, wherein the prescribed feature is one of a plurality of prescribed features available for selective, on-demand, etching of the translucent light guide.
